(19) United States
(12) Patent Application Publication
(10) Pub. No.: US 2012/0301590 A1
(43) Pub. Date: Nov. 29, 2012

(54) HYDRATING GEL COMPOSITION WITH ELECTROLYTES AND STRUCTURE AGENT

(76) Inventor: George CASTILLO, Mission Viejo, CA (US)

(21) Appl. No.: 13/475,815

(22) Filed: May 18, 2012

Related U.S. Application Data
(60) Provisional application No. 61/488,908, filed on May 23, 2011.

(51) Int. Cl. A23L 1/0532; A23L 3/36; A23L 1/30

(52) U.S. Cl. 426/575; 426/573

(57) ABSTRACT

A food product may provide a hydrating gel for rehydration of individuals. The hydrating gel may include water, electrolytes, and a structure agent. The structure agent may be carrageenan. In some embodiments, the hydrating gel may be frozen.

### CROSS-REFERENCE TO RELATED APPLICATION

This application claims benefit under 35 U.S.C. §119(e) of U.S. Provisional Application having Application No. 61/488,908 filed May 23, 2011, which is hereby incorporated by reference herein in its entirety.

### BACKGROUND OF THE INVENTION

The present invention generally relates to food products, and more particularly to a hydrating gel composition with electrolytes and structure agent.

Replenishing vital nutrients and fluids after exertion may be beneficial, particularly on hot days. Typically, rehydration may be done by drinking sports drinks. However, some sports drink bottles may be too large or heavy for the elderly or children to hold. Additionally, sports drink bottles may have more fluid than an individual may need. A bottle may warm within the hot environment and the fluid inside may become unpalatable.

As can be seen, there is a need for a rehydrating food product that may be attractive for children or the elderly to consume during hot days.

### SUMMARY OF THE INVENTION

In one aspect of the present invention, a food product comprises water; electrolytes; and a structure agent, wherein the structure agent forms a hydrating gel when mixed together with the water and electrolytes.

In another aspect of the present invention, a process of providing a rehydrating food product comprises mixing water, electrolytes, and a structure agent into a hydrating gel; and freezing the hydrating gel.

These and other features, aspects and advantages of the present invention will become better understood with reference to the following drawings, description and claims.

### BRIEF DESCRIPTION OF THE DRAWINGS

FIG. 1 is a perspective view of cup of hydrating gel according to an exemplary embodiment of the present invention in use;

FIG. 2 is a front view of the cup of hydrating gel; and

FIG. 3 is a flowchart of a process of providing a hydrating gel according to another exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a food product that may rehydrate individuals. Exemplary embodiments may replace lost nutrients sweated out by individuals, which may be particularly beneficial during a hot day. Embodiments of the present invention may have beneficial applications, such as in sports, health or medical markets. For example, embodiments of the present invention may provide additional hydration resources to patients or individuals, which include the elderly and children, for example.

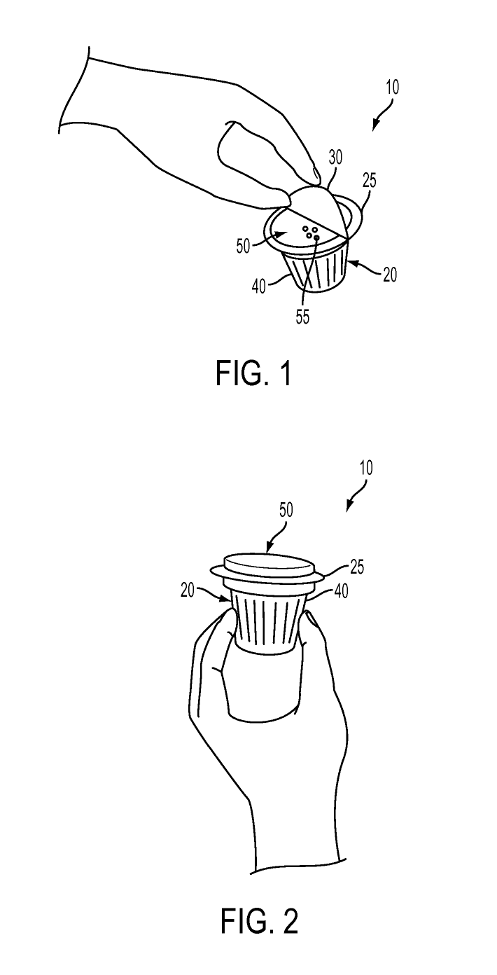

Referring to FIGS. 1 and 2, a food product 10 is shown. The food product 10 may be a hydrating gel 50 packaged in a cup 20. The cup 20 may include a lip 25 and a body 40. The hydrating gel 50 may be sealed in the cup 20 by a lid 30. The body 40 may be a soft squeezable plastic. When the lid 30 is removed, the hydrating gel 50 may be pushed up and out of the cup 20 (FIG. 2).

The hydrating gel 50 may comprise water, electrolytes and a structure agent 55. In an exemplary embodiment, the hydrating gel 50 may be frozen. In another exemplary embodiment, the structure agent 55 may include carrageenan. Carrageenan may provide supplemental support to the hydrating gel 50. When the cup 20 is squeezed, the structure agent 55 may aid the hydrating gel 50 to retain form while outside the body 40. When the hydrating gel 50 is within a warming environment, the carrageenan may slow the melting process. The structuring agent may also allow the frozen food product 10 to have a softer texture than standard frozen items.

The hydrating gel 50 may include natural flavors configured palatable for consumption after freezing. The electrolytes contained in the product may be twice the amount per ounce, for example, than that found in liquid sports drinks. the hydrating gel 50 may further include vitamins and sugar.

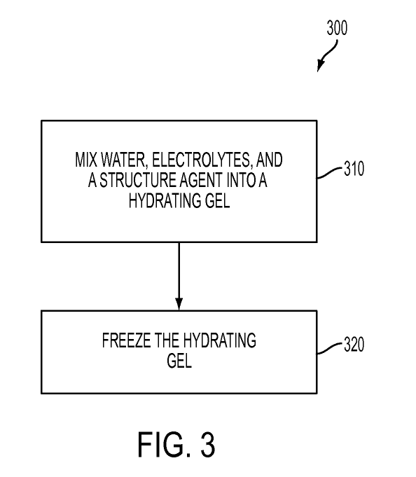

Referring now to FIG. 3, a process of providing a rehydrating food product is shown. Water, electrolytes, and a structure agent may be mixed (step 310) together to form a hydrating gel. The hydrating gel may be frozen (step 320) into a food product for rehydration.

It should be understood, of course, that the foregoing relates to exemplary embodiments of the invention and that modifications may be made without departing from the spirit and scope of the invention as set forth in the following claims.

What is claimed is:

1. A food product, comprising:
water;
electrolytes; and
a structure agent, wherein the structure agent forms a hydrating gel when mixed together with the water and electrolytes.

2. The food product of claim 1 wherein the structure agent is carrageenan.

3. The food product of claim 1 further comprising a sealed cup holding the hydrating gel.

4. The food product of claim 3 wherein the cup includes a soft squeezable plastic body.

5. The food product of claim 1 wherein the hydrating gel is frozen.

6. A process of providing a rehydrating food product comprises:
mixing water, electrolytes, and a structure agent into a hydrating gel; and
freezing the hydrating gel.

7. The process of claim 6 wherein the hydrating gel is frozen in a squeezable cup.
